(19) United States
(12) Patent Application Publication
(10) Pub. No.: US 2019/0380299 A1
(43) Pub. Date: Dec. 19, 2019

(54) SELECTIVELY DEPLOYABLE PET CARRIER ATTACHABLE TO A SEAT IN A VEHICLE

(71) Applicant: Zugo Inc., Austin, TX (US)

(72) Inventors: CAROLYN SHEWFELT, COEUR D'ALENE, ID (US); JULIA BINDI, AUSTIN, TX (US)

(21) Appl. No.: 16/443,573

(22) Filed: Jun. 17, 2019

Related U.S. Application Data
(60) Provisional application No. 62/686,204, filed on Jun. 18, 2018.

(51) Int. Cl. A01K 1/02; B60R 22/10

(52) U.S. Cl. CPC A01K 1/0272; A01K 1/0263; A01K 1/0254; B60R 22/10

(57) ABSTRACT

A booster seat for a pet within a vehicle includes a main body having a lower wall and sidewalls extending therefrom and terminating at a distal edge. The main body is transitional between a deployed configuration and a stowed configuration, with the distal edge being moved toward the lower wall as the main body is transitioned from the deployed configuration toward the stowed configuration. First and second braces are selectively positionable relative to the main body in first and second positions. In the first position, each brace extends between the lower wall and the distal edge to provide support to the main body to maintain the main body in the deployed configuration. In the second position, each support being moved away from the distal edge. The booster seat additionally comprises a first attachment body coupled to the main body and connectable with a portion of the vehicle.

### CROSS-REFERENCE TO RELATED APPLICATIONS

This application claims the benefit of U.S. application Ser. No. 62/686,204, filed Jun. 18, 2018, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a pet travel device, and more specifically, to a device which may be connectable to a vehicle and which may define an enclosure, within which a pet may reside while traveling.

### 2. Description of the Related Art

Pets provide a great deal of companionship and friendship to their owners, and thus, pet owners may have a strong desire to spend as much time as possible with their pet throughout a given day. Although a pet owner may readily interact with their pet while at the owner's residence, the pet owner routinely leaves the residence to run errands and perform other tasks. During such times, the pet may be left alone at the residence while the owner is out.

In some cases, the owner may bring their pet along for the excursion, wherein the pet may ride with the owner in the owner's vehicle from their residence to the destination. Once the owner reaches the remote destination, the owner may a desire to take the pet with her, if the circumstances allow (e.g., if the destination allows pets to accompany their owners).

Although permitting one's pet to travel with the owner on such outings may allow the owner to experience the companionship provided by the pet, there may be inherent safety concerns and potential logistical difficulties which may arise during the course of such outing. For instance, when the pet is in the vehicle, the owner may let the pet roam freely and unrestrained throughout the vehicle. Obviously, a sudden change in speed or a quick turn could cause serious injury to the pet. Moreover, if the pet is roaming freely throughout the vehicle, the pet can easily distract the driver, which may cause an accident. Conversely, if the pet is contained within a conventional cage, the pet may become bored or upset by the unchanging surroundings/scenery.

One solution to this problem is a pet safety system which is shown and described in U.S. Pat. No. 9,295,234, entitled Pet Safety System, the contents of which are expressly incorporated herein by reference. The pet safety system of the '234 patent generally includes a harness worn by the pet, which is attachable to a restraint connected to the vehicle.

While the pet safety system of the '234 patent provides a very convenient system for traveling with one's pet, one of the requirements of the system may be that the pet wears a harness. Accordingly, other alternatives may be desired which may not require the pet to wear a harness

Therefore, it is apparent that there is a need in the art for a pet safety system which allows a pet owner to safely and easily carry one's pet and transport one's pet in a vehicle. Various aspects of the present disclosure address this particular need, as will be discussed in more detail below.

### BRIEF SUMMARY

In accordance with one embodiment of the present disclosure, there is provided a device for providing a secure and stable space for a pet within a vehicle. The device includes a main body having a lower wall and a plurality of sidewalls extending from the lower wall and terminating at a distal edge. The main body is transitional between a deployed configuration and a stowed configuration, with the distal edge being moved toward the lower wall as the main body is transitioned from the deployed configuration toward the stowed configuration. The device additionally includes a first brace and a second brace, each being selectively positionable relative to the main body in a first position and a second position. In the first position, each brace extends between the lower wall and the distal edge to provide support to the main body to maintain the main body in the deployed configuration. In the second position, each support being moved away from the distal edge. The device further includes a lid connectable to the plurality of sidewalls such that the lid and the main body collectively define an enclosure sized to receive the pet. The device additionally comprises a first attachment body coupled to the main body and connectable with a portion of the vehicle for connecting the main body to the vehicle.

The lower wall may be of a stiffness greater than the plurality of sidewalls. The device plurality of sidewalls may be formed from a mesh material.

The first and second braces may be pivotally coupled to the lower wall. The device may further include a pair of flaps selectively connectable to the respective one of the plurality of sidewalls for retaining respective ones of the first and second braces in the first position. Each flap may be connectable to the respective one of the plurality of sidewalls via hook and loop fasteners.

Each of the first and second braces may include a pair of brace legs pivotally coupled to the lower wall, and a distal support arm extending between the pair of brace legs.

The device may additionally include a first pocket panel and a second pocket panel each being connected to at least one of the plurality of sidewalls to form separate first and second pockets. The first and second braces may be elongate rods receivable in pockets when the main body is in the deployed configuration.

The lid may be pivotally connected to the main body between a covered position and an uncovered position, with the lid extending between the plurality of sidewalls when the lid is in the covered position. The device may additionally include a zipper for retaining the lid in the covered position.

The main body may be configured to define a volume which decreases when the main body transitions from deployed to stowed configuration.

The first attachment body may include a first loop adapted to receive a seatbelt on a vehicle. The may additionally comprise a second attachment body including a second loop adapted to receive latch belt, the first and second loops being formed on opposing portions of the main body. The device may additionally comprise a third attachment body including strap having a first end connected to the main body and a second end connectable to a structure on the vehicle.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a pet booster seat in a deployed configuration anchored to a vehicle;

FIG. 2 is an upper perspective view of the pet booster seat in the deployed configuration;

FIG. 3 is a side view of the pet booster seat depicted in FIG. 2;

FIG. 4 is an upper perspective view of the pet booster seat in a stowed configuration;

FIG. 5 is an upper perspective, partial cutaway view depicting a first embodiment of a brace system including a pair of braces, each shown in a brace stow position;

FIG. 6 is an upper perspective, partial cutaway view depicting the pair of braces of FIG. 5, with one brace transitioned into a brace deploy position and the other brace in the brace stow position;

FIG. 7 is an upper perspective, partial cutaway view depicting the pair of braces of FIG. 5 in the brace deploy position;

FIG. 8 is a partial exploded, upper perspective view depicted a second embodiment of a brace system including a plurality of elongate rods receivable in respective pockets formed on the main body; and

FIG. 9 is a partial, enlarged cross sectional view depicting an elongate rod received in a pocket.

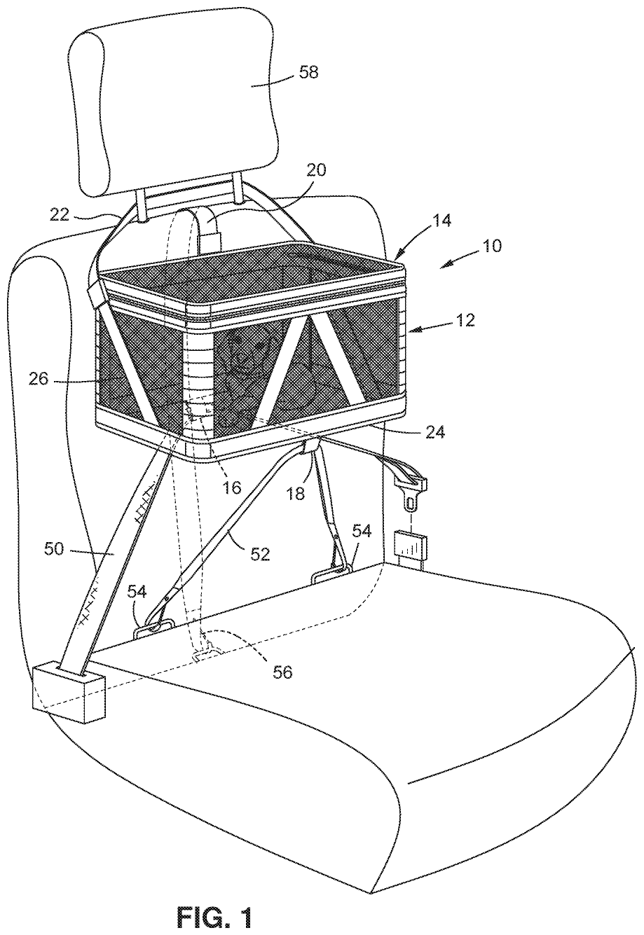

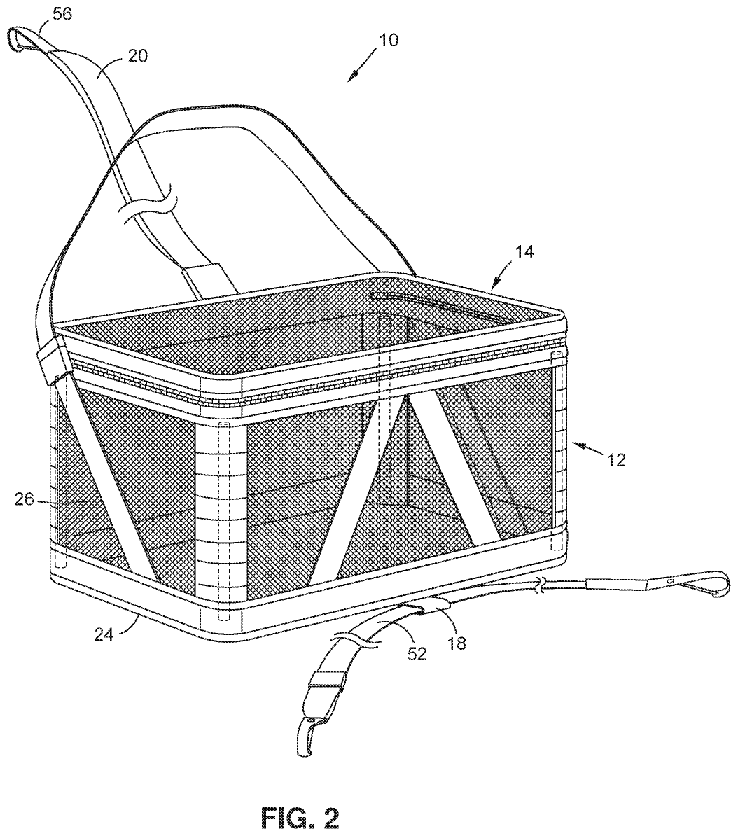

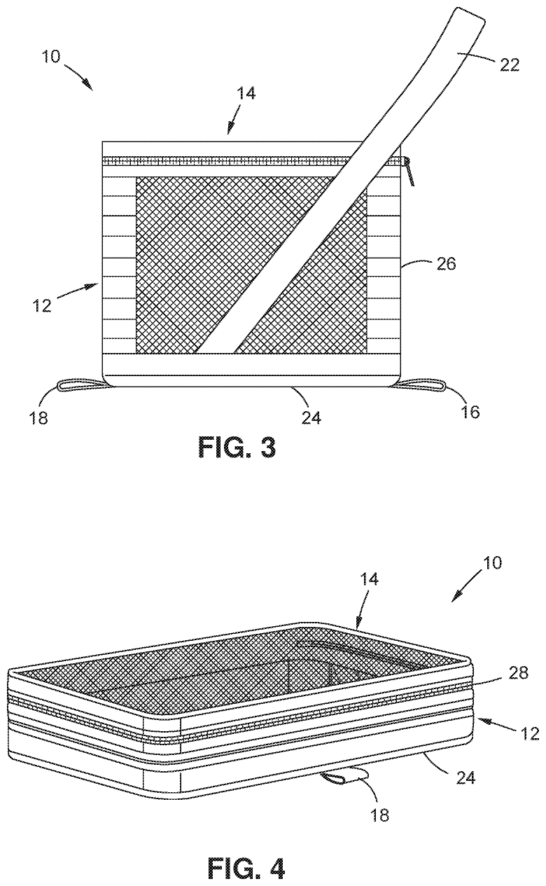

Common reference numerals are used throughout the drawings and the detailed description to indicate the same elements.

### DETAILED DESCRIPTION

Referring now to the drawings, wherein the showings are for purposes of illustrating preferred embodiments of the present disclosure, and are not for purposes of limiting the same, there is depicted a booster seat 10 for providing a secure and stable space for a pet, such as a dog, cat, rabbit, etc., within a vehicle. The booster seat 10 may be specifically configured and adapted to be attached or anchored to the vehicle such that the booster seat 10 is restrained from vertical and horizontal movement within the vehicle. The booster seat 10 may be selectively transitional between a stowed configuration and a deployed configuration, and include a support frame that may be transitional relative to a main body 12 and configuration to support the main body when in the deployed configuration. When the booster seat 10 is in the deployed configuration, the booster seat 10 defines an enclosure within which a pet may be placed and remain while riding in the vehicle. The booster seat 10 may be formed from soft sided, breathable walls and a padded floor to ensure comfort for the pet while in the booster seat 10. The booster seat 10 may also include pockets for pet supplies (e.g., a leash) as well as heating or cooling packets to enhance the comfort of the pet located therein.

The booster seat 10 (e.g., the device) generally includes the main body 12, a lid 14, and several attachment bodies 16, 18, 20, 22 for securing the booster seat 10 to the vehicle. The main body 12 includes a lower wall 24 which may be capable of supporting the pet placed therein. In this regard, the lower wall 24 may include support rods sewn therein, such front and rear support rods, as well as lateral support rods, to maintain a desired shape of the lower wall 24. It is also contemplated that the lower wall 24 may include a rigid body, such as a wood, plastic, or metal panel integrated therein for supporting a pet, or alternatively the lower wall 24 may be formed from a panel that is disposed in tension to support smaller pets. The lower wall 24 may be padded and include a fabric outer surface for comfort. It is also contemplated that the lower wall 24 may include at least a portion of which that is formed from mesh or other perforated materials to enhance airflow therethrough. In the exemplary embodiment, the lower wall 24 is quadrangular in shape; however, it is understood that in other embodiments, the lower wall 24 may be other shapes, including oval, circular, triangular, etc.

The main body 12 additionally includes a plurality of sidewalls 26 extending from the lower wall 24 and terminating at a distal edge 28. The plurality of sidewalls 26 may be a continuous extension of the lower wall 24 or alternatively, they may be separate panels that may be sewn or otherwise secured to the lower wall 24. The plurality of sidewalls 26 may be formed from a mesh material to facilitate airflow through the main body 12 to provide sufficient ventilation to the pet.

According to one embodiment, the main body 12 may be configured to be selectively transitional between a deployed configuration and a stowed configuration. In the deployed configuration, the plurality of sidewalls 26 are upright and generally perpendicular to the lower wall 24, whereas in the stowed configuration, the plurality of sidewalls 26 are folded onto the lower wall 24, such that the main body 12 assumes a compact configuration for storage. Along these lines, as the main body 12 transitions from the stowed configuration toward the deployed configuration, the distal edge 28 is moved away from the lower wall 24 and each of the plurality of sidewalls 26 assumes a generally planar configuration. Conversely, as the main body 12 transitions from the deployed configuration toward the stowed configuration, the distal edge 28 is moved toward the lower wall 24 and at least one of the plurality of sidewalls 26 is folded or bunched up to assume a non-planar configuration. In this regard, the overall volume of the enclosure may increase as the main body 12 transitions from the stowed configuration toward the deployed configuration, and conversely, the overall volume of the enclosure may decrease as the main body 12 transitions from the deployed configuration toward the stowed configuration.

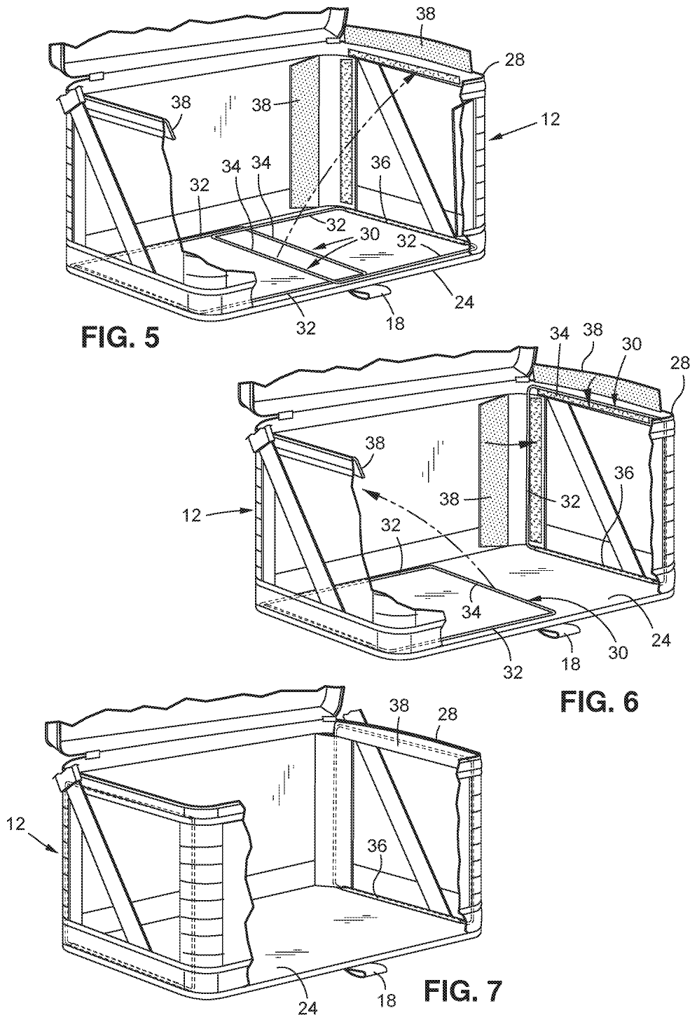

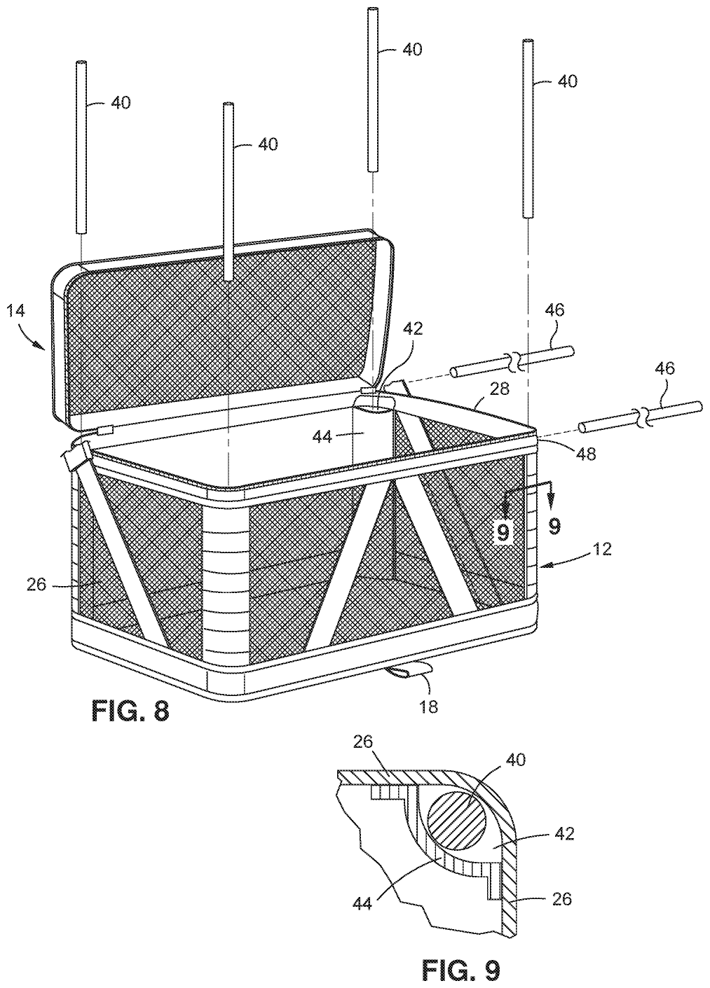

The main body 12, particularly the sidewalls 26, may be formed of a flexible material without internal stiffness or rigidity to allow the main body 12 to transition between the deployed and stowed configurations. Accordingly, the booster seat 10 may include a brace system to support the main body 12 in the deployed position. It is contemplated that the brace system may be any one of several different embodiments. Along these lines, FIGS. 5-7 depict a first embodiment of a brace system, while FIGS. 8-9 depict a second embodiment of a brace system.

Referring first to FIGS. 5-7, the first embodiment of the brace system includes a pair of braces 30 pivotally coupled to the main body 12. In this regard, each brace 30 is selectively transitional between a brace deploy position and a brace stow position. FIG. 5 shows both braces 30 in the brace stow position, FIG. 6 depicts one brace 30 transitioned into a brace deploy position and the other brace 30 in the brace stow position. FIG. 7 is an upper perspective, partial cutaway view depicting the pair of braces 30 of FIG. 5 in the brace deploy position. In the exemplary embodiment, each brace 30 pivots approximately ninety degrees between the brace stow position and the brace deploy position.

Each brace 30 may include a pair of brace legs 32 pivotally coupled to the main body 12, and a distal support arm 34 extending between the pair of brace legs 32. In this regard, each brace leg 32 may include an end portion that may be received in a sleeve 36 or slot formed in the lower wall 24 or a lower portion of a sidewall 26. Alternatively, for a more robust connection, each brace 30 may be connected to the main body 12 via a pivot hinge which allows for pivotal motion of the brace 30 between the brace deploy position and the brace stow position.

According to one embodiment, the booster seat 10 may include closure flaps 38 for securing the braces 30 to the main body 12 when the braces 30 are in the brace deploy position. In the exemplary configuration, a pair of upper closure flaps 30 are connected to opposed lateral sidewalls 26. The upper closure flaps 30 may extend parallel to or along the distal edge 28 with each flap 30 being moveable between an open/release position, and a closed/secured position. Each flap 30 is moved to the open/release position as the corresponding brace 30 is moved to the brace deploy position. The flap 30 may be transitioned to the closed/secured position, wherein the flap 30 overlaps with the corresponding lateral sidewall 26 to capture the distal support arm 34 between the flap 30 and the lateral sidewall 26. The exemplary embodiment also includes several side closure flaps 30 extending between the lower wall 24 and the distal edge 28. The side closure flaps 30 may be transitional between open/release and closed/secured positions, with the side closure flaps 30 capturing a respective brace leg 32 when the brace 30 is in the brace deploy position and the side closure flap 30 is in the closed/secured position.

Fasteners may be used to detachably secure the flap 30 to the sidewall 26. In the exemplary embodiment, the fasteners include hook and loop fasteners (e.g., VELCRO™) although in other embodiments, the fasteners may include snaps, buttons, magnets, zippers, etc.

Although the foregoing describes the use of flaps 30 for securing the braces 30 in their respective brace deploy positions, as an alternative to using flaps 30 for retaining the braces 30 in the brace deploy position, the booster seat 10 may include clips attached to the main body 12 which connect to the braces 30 and retain the braces 30 in the brace deploy position. As another alternative, if the braces 30 are connected to the main body 12 via hinges, the hinges may include camming surfaces or detents to retain the braces in the brace deploy position unless an overriding force is applied to the brace 30 to move the brace 30 out of the brace deploy position.

Referring now to FIGS. 8 and 9, there is depicted a second embodiment of the brace system, which includes the use of elongate rods 40 which may be selectively inserted within pockets 42 formed on the main body 12. More specifically, the main body 12 includes several pocket panels 44, each being coupled to one or more sidewalls 26 for forming a respective pocket 42 between the pocket panel 44 and the sidewalls 26. In the exemplary embodiment depicted in FIGS. 8 and 9, the pocket panels 44 are located in respective corners of the main body, with each pocket panel 44 extending between an adjacent pair of sidewalls 26. Each pocket 42 may include at least one open end, with at least one rod 40 being insertable into a corresponding pocket 42 via the open end. Along these lines, each pocket 42 may extend along a pocket axis, and each elongate rod 40 may be insertable into the pocket 42 and removable from the pocket 42 along the corresponding pocket axis when the main body is in the deployed configuration. The pocket panels 44 may be formed from a flexible material that is foldable and collapsible with the main body 12 as the main body 12 transitions between the deployed configuration and the stowed configuration.

Each of the elongate rods 40 are rigid and may be formed from plastic, metal, wood, or other materials known in the art. Furthermore, the rods 40 may be sized so as not to extend or protrude out of the pockets 42 when the rods 40 are received in the pockets 42. In this regard, the rods 40 may be of a length that is less than the distance between the lower wall 24 and the distal edge 28.

The booster seat 10 may additionally include front and rear stabilizing rods 46, which may be selectively insertable into respective sleeves formed in the front and rear sidewalls 26. The stabilizing rods 46 may provide rigidity to the front and rear sidewalls 26. Whereas the elongate rods 40 are removed from their respective pockets 42 as the main body 12 transitions between the deployed and stowed configurations, the front and rear stabilizing rods 46 may remain in their respective sleeves, particularly if the user does not care to fold the booster seat 10 about a transverse axis extending between the front and rear sidewalls 26.

As noted above, the booster seat 10 may include a lid 14 for selectively opening and closing the booster seat 10. Along these lines, the lid 14 may assume a covered position and an uncovered position, relative to the main body 12. In the covered position, the lid 14 extends across an upper opening of the main body 12 to form an enclosure collectively with the main body 12. In the uncovered position, at least a portion of the lid 14 is moved away from the main body 12 to uncover the upper opening of the main body 12. A user may place the lid 14 in the covered position when the pet is placed in the main body 12 to contain the pet therein, e.g., to prevent the pet from inadvertently falling out or jumping out. A user may place the lid 14 in the uncovered position to retrieve the pet from the main body 12, or to provide a more open feel for the pet, particularly if there is less of a concern of the pet escaping the main body 12. The lid 14 may include a mesh panel to enhance ventilation through the booster seat 10, and also to allow the pet to see out of the booster seat 10, while also allowing the user to view the pet within the booster seat 10.

In the exemplary embodiment, the lid 14 is pivotally connected to the main body 12, with the lid 14 being a continuous extension of one of the sidewalls 26. In this regard, the lid 14 may be pivotable relative to the underlying sidewall 26 via a seam or living hinge. It is also contemplated that in other embodiments, the lid 14 may be completely detachable from the main body 12 when the lid 14 is in the uncovered position.

The lid 14 may include a fastener for retaining the lid 14 in the covered position. The fastener may include a zipper, having one portion coupled to the lid and the complementary portion coupled to the sidewalls 26. In other embodiments, the fastener may include snaps, buttons, magnets,

The booster seat 10 may include several components (e.g., attachment bodies) which facilitate attachment, securement, and/or anchoring of the booster seat to the vehicle. A pair of loops 16, 18 may be connected to the main body 12 adjacent the rear and front, respectively, for receiving a seatbelt 50 or a LATCH (Lower Anchors and Tethers for Children) belt 52. The LATCH belt 52 may be connected to LATCH anchors 54 mounted on the vehicle. Once the seatbelt 50 and LATCH belt 52 are passed through the loops 16, 18, they may be cinched or tightened.

The booster seat 10 may additionally include a rear anchor strap 20 and a headrest strap 22, both of which may be connected to the main body 12. The rear anchor strap 20 may be adjustable and include a clip 56 at a distal end thereof, which is connectable to a bracket or anchor on the vehicle. The headrest strap 22 may be configured to extend around a headrest and keep the main body 12 elevated off the bottom of the vehicle seat. The headrest strap 22 may extend over opposed lateral sidewalls 26 and connect with opposed portions of the lower wall 24 for providing a robust and secure connection with the main body 12.

The booster seat 10 may additionally comprise a second attachment body including a second loop adapted to receive latch belt, the first and second loops being formed on opposing portions of the main body 12. The device may additionally comprise a third attachment body including strap having a first end connected to the main body 12 and a second end connectable to a structure on the vehicle.

In addition to the foregoing, the booster seat 10 may include pockets in sidewalls 26 and/or the lower wall 24 for storage or for placement of heat packs or cool packs for providing a more comfortable environment for the pet.

The booster seat 10 may provide a desirable solution for traveling with one's pet. Prior to the trip, the booster seat 10 may be transitioned to the deployed configuration and connected to the vehicle using the loops 16, 18, 20 and/or strap 22. The pet may be placed in the main body 12 and the lid 14 may be closed, with the pet remaining safely within the main body 12 for the duration of the trip. The size of the main body 12 may be sufficient such that the pet may not feel crowded and may remain comfortable during the trip. The mesh sidewalls 26 and lid 14 may allow air from the climate-controlled environment of the vehicle to pass through the booster seat 10 to keep the pet comfortable. Upon arrival, the lid 14 may be opened and the pet retrieved from the booster seat 10. Should the user want to store the booster seat 10, the various connections may be undone to detach the booster seat 10 from the vehicle. The braces may be moved to their brace stow positions and the main body 12 may be folded to assume the storage configuration.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A device for providing a secure and stable space for a pet within a vehicle, the device comprising:
a main body having a lower wall and a plurality of sidewalls extending from the lower wall and terminating at a distal edge, the main body being transitional between a deployed configuration and a stowed configuration, the distal edge being moved toward the lower wall as the main body is transitioned from the deployed configuration toward the stowed configuration;
a first brace and a second brace, each being selectively positionable relative to the main body in a first position and a second position, in the first position, each brace extends between the lower wall and the distal edge to provide support to the main body to maintain the main body in the deployed configuration, in the second position, each support being moved away from the distal edge;
a lid connectable to the plurality of sidewalls such that the lid and the main body collectively define an enclosure sized to receive the pet; and
a first attachment body coupled to the main body and connectable with a portion of the vehicle for connecting the main body to the vehicle.

2. The device recited in claim 1, wherein the lower wall is of a stiffness greater than the plurality of sidewalls.

3. The device recited in claim 1, wherein the plurality of sidewalls are formed from a mesh material.

4. The device recited in claim 1, wherein the first and second braces are pivotally coupled to the lower wall.

5. The device recited in claim 4, further comprising a pair of flaps selectively connectable to the respective one of the plurality of sidewalls for retaining respective ones of the first and second braces in the first position.

6. The device recited in claim 5, wherein each flap is connectable to the respective one of the plurality of sidewalls via hook and loop fasteners.

7. The device recited in claim 1, wherein each of the first and second braces include a pair of brace legs pivotally coupled to the lower wall, and a distal support arm extending between the pair of brace legs.

8. The device recited in claim 1, further comprising a first pocket panel and a second pocket panel each being connected to at least one of the plurality of sidewalls to form separate first and second pockets, the first and second braces being elongate rods receivable in pockets when the main body is in the deployed configuration.

9. The device recited in claim 1, wherein the lid is pivotally connected to the main body between a covered position and an uncovered position, the lid extending between the plurality of sidewalls when the lid is in the covered position.

10. The device recited in claim 9, further comprising a zipper for retaining the lid in the covered position.

11. The device recited in claim 1, wherein the main body is configured to define a volume which decreases when the main body transitions from deployed to stowed configuration.

12. The device recited in claim 1, wherein the first attachment body includes a first loop adapted to receive a seatbelt on a vehicle.

13. The device recited in claim 12, further comprising a second attachment body including a second loop adapted to receive latch belt, the first and second loops being formed on opposing portions of the main body.

14. The device recited in claim 13, further comprising a third attachment body including strap having a first end connected to the main body and a second end connectable to a structure on the vehicle.

15. A device for a pet within a vehicle, the device comprising:
a body having a lower wall and a plurality of sidewalls extending from the lower wall and terminating at a distal edge, the main body being transitional between a deployed configuration and a stowed configuration, the distal edge being moved toward the lower wall as the main body is transitioned from the deployed configuration toward the stowed configuration;
a first brace and a second brace, each being selectively positionable relative to the main body in a first position and a second position, in the first position, each brace extends between the lower wall and the distal edge to provide support to the main body to maintain the main body in the deployed configuration, in the second position, each support being moved away from the distal edge;
a first attachment body coupled to the main body and connectable with a portion of the vehicle for connecting the main body to the vehicle.

16. The device recited in claim 15, wherein the first and second braces are pivotally coupled to the lower wall.

17. The device recited in claim 16, further comprising a pair of flaps selectively connectable to the respective one of the plurality of sidewalls for retaining respective ones of the first and second braces in the first position.

18. The device recited in claim 17, wherein each flap is connectable to the respective one of the plurality of sidewalls via hook and loop fasteners.

19. The device recited in claim 15, wherein each of the first and second braces include a pair of brace legs pivotally coupled to the lower wall, and a distal support arm extending between the pair of brace legs.

20. The device recited in claim 15, further comprising a first pocket panel and a second pocket panel each being connected at least one of the plurality of sidewalls to form separate first and second pockets, the first and second braces being elongate rods receivable in pockets when the main body is in the deployed configuration.
